(19) United States
(12) Patent Application Publication
(10) Pub. No.: US 2015/0304231 A1
(43) Pub. Date: Oct. 22, 2015

(54) GENERIC RESOURCE PROVIDER FOR CLOUD SERVICE

(71) Applicant: Hewlett-Packard Development Company, L.P., Houston, TX (US)

(72) Inventors: Prashant Gupte, Sunnyvale, CA (US); Norman Kincl, San Jose, CA (US); Stephane Herman Maes, Fremont, CA (US)

(21) Appl. No.: 14/646,113

(22) PCT Filed: Dec. 3, 2012
(86) PCT No.: PCT/US2012/067596

§ 371 Date: May 20, 2015

(51) Int. Cl. H04L 12/911; H04L 29/08

(52) U.S. Cl. CPC H04L 47/70; H04L 67/10

(57) ABSTRACT

Systems and methods are provided for providing a cloud service. A service design defining the cloud service is generated and stored in memory during a design stage of cloud service provision. A specific provider for the defined cloud service is selected from a plurality of available specific resources during a subscription stage. The cloud service defined in the service design is provided using the selected specific provider.

### BACKGROUND

A cloud service generally refers to a service that allows end recipient computer systems (thin clients, portable computers, smartphones, desktop computers and so forth) to access a pool of hosted computing and/or storage resources (i.e., the cloud resources) and networks over a network (the Internet, for example). In this manner, the host, a cloud service provider, may, as examples, provide Software as a Service (SaaS) by hosting applications; Infrastructure as a Service (IaaS) by hosting equipment (servers, storage components, network components, etc.); or a Platform as a Service (PaaS) by hosting a computing platform (operating system, middleware, data bases, autoscaling infrastructure, etc.).

A typical cloud service incurs charges on a demand basis, is managed by the cloud service provider and may be scaled (scaled according to desired storage capacity, processing power, network bandwidth and so forth) by the end user. The cloud service may be a public service (an Internet-based service, for example) that is generally available to all potential users or a limited access private service that is provided over a private network (a business enterprise network, for example) as well as a managed cloud service—private or hosted—(e.g., a virtual private cloud service) or a hybrid cloud service (a cloud service that is a combination of the above). Traditionally, when a user orders a cloud service, the user may manually perform various actions related to deploying and configuring software associated with the ordered cloud service (e.g., deployment of virtual machines (VMs), middleware, application software, application components, and so forth) on the provisioned/instantiated infrastructure.

### BRIEF DESCRIPTION OF THE DRAWINGS

FIG. 1 illustrates one example of a cloud service provisioning system.

FIG. 2 illustrates another example of a cloud service system utilizing generic resource providers.

FIG. 3 is a flow diagram illustrating one example of how the parameters used to select a specific provider for a given cloud service can be selected.

FIG. 4 illustrates a method for providing a cloud service.

FIG. 5 is a schematic block diagram illustrating an exemplary system of hardware components capable of implementing examples of the systems and methods for user defined function integration disclosed in FIGS. 1-4.

### DETAILED DESCRIPTION

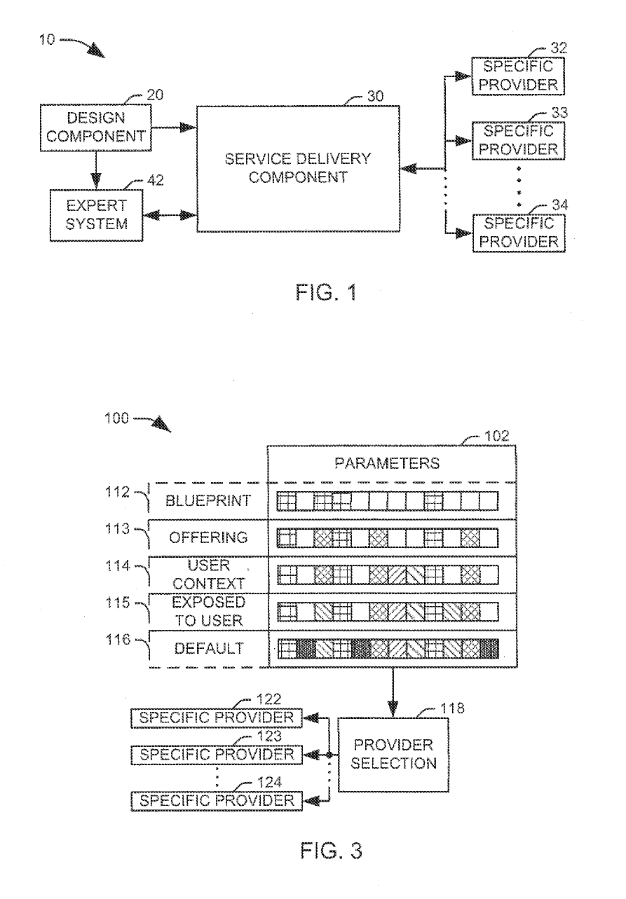

FIG. 1 illustrates one example of a cloud service provisioning system 10. The provisioning system 10 includes a design component 20 configured to create a service design for a cloud capability, that is, a collection of available cloud services, in collaboration with a user. A service design can include, for example, a set of actions to instantiate the cloud capability as well as a collection of resources to be utilized in the instantiation of the cloud capability. In the system of FIG. 1, the service design can define a given resource as a generic provider for a given service and a set of parameters associated with the specified general provider. For example, the set of parameters can include parameters representing quality of service requirements, (e.g., an amount of storage space, bandwidth, priority, overall load of system and processing capacity) and business, or contextual, policy parameters (e.g., type of application and security requirements, location, who is allowed to use what (e.g., tiered offerings)). It will be appreciated that the various parameters can include categorical parameters, ordinal values, interval values, and ratio values, and can be provided from decisions made by the user, system administrators, or automatically by the system in the form of default values or valued estimated form the overall context (e.g., current date, time, location, temperature, load, type of user, etc).

The service design can be provided to a service delivery component 30 for implementation as a cloud service. In the example of FIG. 1, the service design, rather than associating the provided services with specific cloud resources, contains generic service providers. A generic service provider represents a cloud resource in the abstract, according to its associated function, without tying the resource to a specific type or location or resource. For example, the design may include a generic server, without restricting the resource to a specific physical server assembly or even restricting it to a physical or virtual implementation. It will be appreciated that multiple types of generic provider can be available for use in a given service design, including, for example, server resources, network structures, data storage, software applications, monitoring, and management interfaces.

A specific resource for each generic provider specified in the service design is selected from a plurality of available specific providers 32-34. A specific provider 32-34 represents a specific set of physical or virtual cloud resources that can be used to perform an associated function, and unlike the generic resource, is tied to a specific location and type of resource. For example, both physical and virtual servers can represent specific providers for a generic server resource, and one specific server resource that might be associated with a generic server resource may include a physical server assembly located in a particular data center. Once the specific resource is selected, the service delivery component instructs each generic resource selected at the design component 20 to implement all public actions exposed by the selected specific provider, effectively transforming it into an instantiation of the specific provider.

The selection of a specific resource for each generic resource takes place at an expert system 42, in communication with the service delivery component 30, that selects the specific resource provider for the service design according to at least a set of parameters derived from the service design. It will be appreciated that the expert system can receive parameters from any of the service delivery component, the service design itself, and external systems. These parameters can include, for example, business policy values, quality of service (QoS) parameters, values drawn from user context, values concerning constraints on available resources in the cloud system, and other contexts of the system or the environment, such as a similarity of network topology. In one example, the expert system 42 is a rule-based expert system that determines an appropriate specific provider for each generic provider according to the various parameters associated with the service design, a service blueprint from which the service design was generated, the identity of the user, the relationship of the user to the system, and constraints on various data centers within the cloud system. For example, the rules of the expert system can be configured to balance the use of resources across multiple specific resources while providing a service appropriate to the business policy and quality of service requirements of the user. It will be appreciated, however, that any policy-based decision technology can be used to implement the expert system 42.

It will be appreciated that the system 10 can be implemented using a processing resource, comprising one or more processors, and a memory resource, comprising one or more non-transitory computer readable media. It will be appreciated that a given memory resource or processing resource can consist of multiple discrete components which may be spatially distinct and connected via a network fabric. Each of the design component 20, the service delivery component 30, and the expert system 42 can be implemented as machine executable instructions stored in the memory resource and executable by the processing resource. Alternatively, each component 20, 30, and 42 can represent one or more processing components and one or more non-transitory computer readable media connected via a network fabric, with instructions stored on the one or more media that are executable to perform the function of the component.

Selecting a specific provider to perform a task at “run-time” instead of “design time” provides a number of advantages. For example, it allows a better separation of concerns between the various roles and functions. Once the design has been established, the underlying provider infrastructure can be changed without affecting a given service. No change is needed to the service design, across any of the different cases supported by the policies. All of the complexities of specific provider and the policies that they support are abstracted to functional requirements, such that designers will work with one provider for a given resource type with a single set of offerings. The service deployment is controlled by modifying or adding to the set the business police and quality of service parameters in the service blueprint and offering, which drives the selection of the specific provider.

In practice, the service definition is “top-down”, wherein based on functional requirements and SLA, the topology, base resource units & attributes, and connectors for resource units all need to be deployed with run time resolution of business policies and data center constraints. The illustrated system allows the service to be implemented in accordance with this top-down structure. It also provides an efficient division of labor in implementing the system. A service designer is typically an expert in functional requirements, while administrators are experts in their specific resource providers. By deferring the selection of a specific provider until the subscription stage, the illustrated system allows the service designed to concentrate on design and the administrators to implement the provider best suited for the design, providing an efficient division of responsibilities.

In systems in which the specific provider is resolved at design time, service designs are locked to snapshot in-time of customer data center infra-structure topology. The illustrated system completely eliminates these constraints, and allows extreme flexibility and transportability of service designs, removes dependency on physical data center constraints, providing the ability to fine tune business processes, quality of service definitions, and other policies up to the time of subscription to the service.

Using the generic provider model to resolve a specific provider at run time, allows for a transition from a traditional data center model to provision of hybrid clouds via private and public clouds with minimal design investment. The model also allows for unconstrained extensibility. In particular, existing generic resource types can be extended with new provider-specific parameters and appropriate mapping rules or contextual policies, that is, any combination of condition to action based on context at execution. New types of generic components can be introduced by creating a new or enhanced set of provider-specific parameters. New business policies can be defined by adding new business policy parameters and the associated mapping rules to the expert system. In all cases, existing services will continue to work, being allocated default values of the new properties. Since the existing service is unaware of the new capability, getting a default value will not cause service problems.

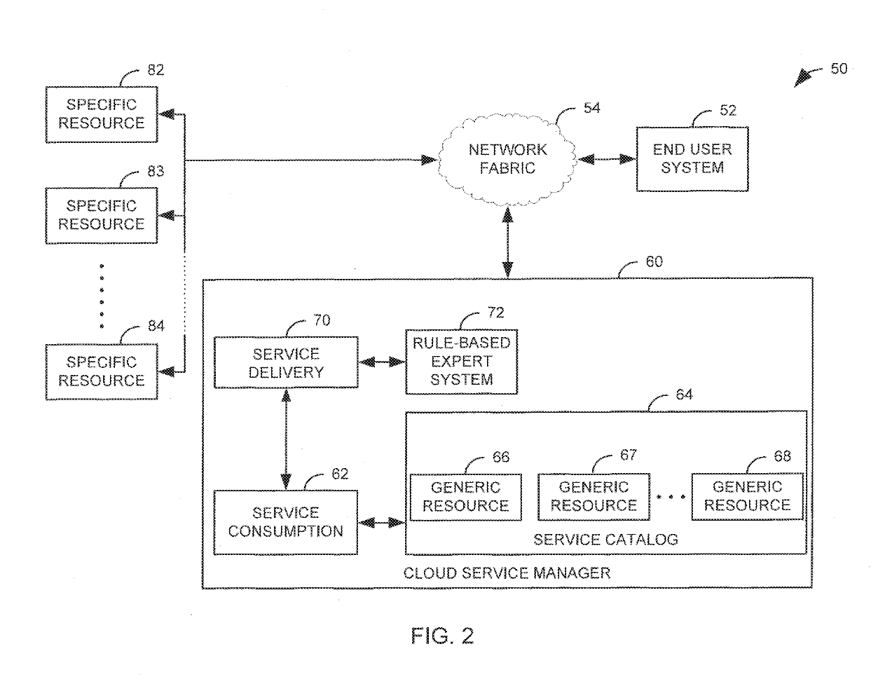

FIG. 2 illustrates another example of a cloud service system 50 utilizing generic resource providers. A cloud service manager 60 offers and delivers (instantiates, provisions, and deploys, for example) services to manage the lifecycles (e.g., manage the building, ongoing management, reporting, metering, reporting and so forth) of existing cloud services and combinations of these existing cloud services for end users. In the illustrated example, the cloud service manager 60 orchestrates the use of application programming interfaces (APIs) of existing cloud services for managing the lifecycles of the existing cloud services and combinations of the existing cloud services for users of user end systems 52 (desktops, portable computers, smartphones, clients, thin clients, servers, and so forth).

Depending on the particular implementation, the selection and ordering of the cloud lifecycle management services may be performed by a given user (an administrator, for example) for a group of end users (users of an enterprise, for example), or the selection and ordering of the cloud capabilities may be performed by a given user (an Internet-based user or employee, for example) for the given user's individual use.

As depicted in FIG. 2, the cloud service manager 60 may be accessed by a given end user system 52 via network fabric 54 formed from one or more of local area network (LAN) fabric, wide area network (WAN) fabric, Internet fabric, and so forth). As such, depending on the particular implementation, the cloud service manager 60 may reside on an Internet server, reside on a server within a private LAN, reside on a server within a WAN, reside on a desktop computer, or may be a web or SaaS (Software as a Service), as just a few examples.

In general, the users of the cloud service manager 60 may select and order “cloud capabilities” through the cloud service manager 60. The phrase “cloud capabilities,” as used herein refers to combinations of existing cloud services that are provided by existing cloud resources, as well as lifecycle management services that are offered and delivered by the cloud service manager 60. While cloud-capabilities can be generated via user interaction through a user portal or other interface, it will be appreciated that a service design for a cloud capacity can be generated programmatically via APIs that expose cloud functionalities to requesting applications. The cloud capabilities are, in general, associated with services that are associated with a “cloud,” which may be, as examples, a public cloud (a cloud formed from an Internet-based network and provides hosted cloud services that are generally available to members of the public), a private cloud (a cloud formed from a private, limited access network, (such as an enterprise network) which provides hosted cloud services to a limited group of members), a virtual private cloud (a cloud formed from a public network providing hosted cloud services to a limited group of members), or a hybrid cloud (a cloud formed from a combination of two or more of the aforementioned clouds). In the illustrated example, the cloud service manager 60 contains a storefront or marketplace module with a user interface that allows a user to access a service consumption module 62 for purposes of browsing and selecting offered cloud capabilities. Moreover, through the access to the service consumption module 62, users may further customize (e.g., configure, for example) details of the selected cloud capabilities; agree to terms and/or conditions for receiving the selected cloud capabilities; order the cloud capabilities (subscribe to the capabilities, pay for the capabilities, and so forth); potentially build or modify a “recipe”, specifying a way to combine multiple cloud capabilities or provide lifecycle management; subsequently update the cloud capability selection(s); scale up and scale down the cloud capabilities; and in general, manage the lifecycle(s) of the ordered cloud capabilities, including retiring the capabilities.

To facilitate this user selection and control, the service consumption module 62 can access one or multiple cloud service catalogs 64 (depending on the particular implementation) and/or different views of the same catalog, which describe available cloud capabilities. The catalog may be a federation or aggregation of catalogs. The users may browse through the catalog 64 using, for example, a graphical user interface (GUI). In accordance with some implementations, the service consumption module 62 may contain one or more APIs/interfaces for purposes of permitting users to browse through the catalog 64.

More specifically, via the service consumption module 62, users may select combinations of various generic resources 66-68 to form a selected set of cloud services and, in general, set up a service to manage the lifecycle of this combination for a given user or group of users. As examples, the existing cloud resources 66-68 may include Infrastructure as a Service (IaaS) resources, such as servers, storage components and network components, a Platform as a Service (PaaS) resources, which are resources that provides a hosted computing platform such as operating systems, hardware, and storage, Software as a Service (SaaS) resources, which that provides hosted applications, and DataBase as a Service (DBaaS) resources, which provides a hosted database as a service. Each of these resources 66-68 is not tied to a specific physical or virtual resource, but is instead a generic placeholder for a resource or set of resources needed to provide the selected cloud resource.

In addition to presenting the service offerings, the service consumption module 62 can regulate user subscriptions to cloud services, in accordance with example implementations. In the illustrated example, the service consumption module 62 may contain such other information as user login components (components containing passwords, login identifications and so forth); user and tenant information; user subscription components (components describing subscription contract terms, subscription rates, and so forth); and an engine that contains logic that allows access and modification to the offered services, updating of subscription data, updating of login information and so forth.

The cloud service manager 60 contains a service delivery module 70 to deliver services that are described in the catalogs and are selected by the users. More specifically, in accordance with example implementations, using the palette of available cloud resources and their resource offerings and actions, cloud service designers and/or administrators may construct plans, or “service blueprints,” which are stored in a memory associated with the service delivery module and set forth structured plans of automated actions for instantiating, configuring, and/or managing the cloud capabilities that are described and offered in the catalog 64.

For a given service blueprint, the service delivery module 70 may automatically undertake the actions to instantiate and configure an associated cloud capability, thereby limiting manual actions by the users pertaining to instantiation and configuration of the selected cloud capability. In accordance with example implementations. the service blueprint is a set of workflows/recipes/scripts that correspond to particular lifecycle management actions that may be performed to orchestrate the APIs of the appropriate cloud resources for purposes of managing the lifecycle of a given cloud capability. In the illustrated example, the generic provider, prior to the selection of a specific provider, can perform a set of actions defined in the blueprint, for example, relating to service topology or the functionality represented by the generic resource. During subscription, the generic provider is essentially transformed into the selected specific provider, and will perform resource-specific actions associated with the selected resource. In accordance with example implementations, designers/administrators and/or users may utilize the service delivery module 70 to orchestrate/compose multiple service blueprints into service blueprints of new cloud capabilities, modify existing service blueprints, and construct new service blueprints.

In accordance with example implementations, a service blueprint may be associated with various commercial terms, such as prices; contract periods; terms associated with a service level agreement (SLA); and so forth, which are stored in subscription components of the service composition module 66. A service becomes a service offering when associated to these terms. These terms that accompany a given service blueprint may be described in the catalog, in accordance with some implementations and, in general, may be set forth by a product designer. A given service blueprint may further specify actions that are taken to handle errors associated with given composition cloud service are handled and actions that taken to report such errors. In general, other service blueprints may specify how the lifecycle of a given service composition is monitored and managed during the full lifecycle of the service. From the final blueprint, respective sets of parameters for one or more generic resources 66-68 associated with the can be extracted representing each of these terms and lifecycle parameters, as well as other relevant parameters from the design.

From a given service blueprint, one or more service offerings can be provided to a user at the service consumption component 62 with the selected offering providing a service design for managing or constructing a cloud service. Each service offering can represent additional parameters defining the requirements for selecting and configuring the specific provider. Once a user has selected a service offering, additional parameters can be added according to the identity of the user and a relationship of the user to the system. Some parameters are exposed to the user and directly defined via a user interface. Where a parameter has not been assigned a value, a default value for that parameter can be assigned.

Once all of the parameters have been assigned, the service delivery component 70 constructs a cloud service from the service offering. To this end, the cloud service manager 60 includes a rule-based expert system 72 to select one of a plurality of specific providers 82-84 for each generic provider in the service offering. It will be appreciated that the expert system 72, while illustrated herein within the cloud service manager, can instead comprise an external system connected through the network fabric 54, a part of the service consumption component 62, or a part of the service delivery component 70. The rules utilized by the rule-based system can enforce business policies, quality of service requirements, contractual terms with the user, and other considerations of the service implementation in selecting the specific provider. Once the specific provider is selected, the service is initiated according to the defined service offering with the specific provider utilized in place of the generic provider defined in the offering. It will be appreciated that selecting the specific provider will also involve determining the appropriate parameters for that specific provider to instruct it to configure the service in a way that meets the required objectives, which can differ from the parameters used in selecting the specific provider. These configuration parameters for the specific provider can include, for example, template names, number of CPUs, disk size, or any other parameters required by the specific provider to properly provision a service component. Any required configuration parameters for the specific provider will be determined by the expert system as part of selecting the specific provider.

FIG. 3 is a flow diagram 100 illustrating one example of how the parameters used to select a specific provider for a given cloud service can be selected. By using a generic provider in place of a specific resource until subscription time, it is possible for policy values to be specified where it is most appropriate, either service design, offering, or subscription. In FIG. 3, a subset of a total set of parameters 102 are defined at each of a plurality of policy decision points 112-116, each representing a different point in the design and deployment process. Once all of the parameters have been defined, a specific provider selection 118 is made based on those parameters to assign the cloud service to an associated specific provider of a plurality of specific providers 122-124.

At a first policy decision point 112, a first subset of parameters are extracted from a service blueprint. These parameters can include values intrinsic to the service design itself, which is assembled by the user from available components in the system. For example, two servers in a disaster recovery service are generally selected to be geographically separated. A parameter detailing this requirement can be determined from the service blueprint. Similarly, certain services can have minimum quality of service requirements, which can be enforced at the design stage.

At a second policy decision point 113, a second subset of parameters are defined for each of a plurality of service offerings. In general, the parameters for each offering will be generated by the design component of the system, and the user selects among the plurality of service offerings to provide the parameters for this decision point 113. It will be appreciated that, as is illustrated in FIG. 3, one or more parameters determined at the first decision point 112 can be altered at this point. In one example, the offerings can represent different applications, with the parameters associated with each offering enforcing policy decisions associated with the application. For example, where the generic resource is a server, an offering for a research and development application having an offering with parameters indicating that the server should be selected from servers located within test labs, or an offering for a product production application having an offering with parameters indicating that server should be selected from servers within tier four data centers. It will be appreciated that each of the first and second decision points 102 and 103 occur during a design phase of the cloud service provision.

At a third policy decision point 114, a third subset of parameters are defined according to user context. Parameters based on user context can include, for example, parameters reflecting characteristics of the user (e.g., geographic location, type of business, etc.) as well as parameters representing the relationship of the user to the system. For example, the status of a user as a premium customer might be one user context parameter, which might affect providing monitoring or allow for access to specific resources reserved for such customers. At a fourth policy decision point 115, a fourth subset of values are exposed to the user to capture the user's preference. For example, the user might select a number of central processing units (CPUs) on a machine used to provide the specific resource.

At a fifth policy decision point 106, all remaining parameters in the set of parameters are assigned to default values. These default values can be inherited from parent object or represent general default values assigned to all generic providers of a given type. If no default parameter is available for a given parameter within the set, the process can be halted and the situation brought to the attention of an operator. Once the set of parameters is complete, the specific provider selection 108 assigns a specific provider (e.g., 113) to the generic provider in the service offering during subscription to the service. Specifically, an expert system analyzes all of the parameters provided, including the default values, if any, and uses a set of rules or policies provided and updated by an administrator to select a single specific provider and the required configuration parameters for that provider. The rule set used to resolve the generic provider to a specific provider can vary in complexity and can differ for different types of generic providers. Once the specific provider is selected, the generic provider implements all public actions exposed by specific provider, transforming itself into an instantiation of specific provider.

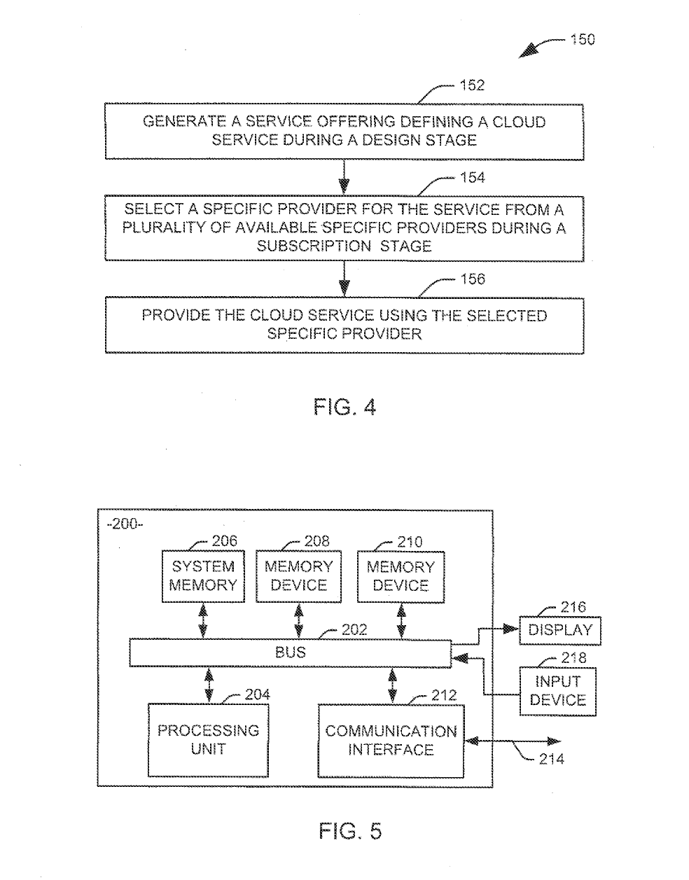

FIG. 4 illustrates a method 150 for providing a cloud service. It will be appreciated that the method 150 can be implemented using a processing resource, comprising one or more processors, and a memory resource, comprising one or more non-transitory computer readable media. It will be appreciated that a given memory resource or processing resource can consist of multiple discrete components which may be spatially distinct and connected via a network fabric. At 152, a service offering is generated defining the cloud service during a design stage of cloud service provision. In one implementation, the service offering is generated by creating a service blueprint representing the cloud service, which contains a generic provider for the cloud service, and then generating a plurality of service offerings as instantiations of the service blueprint. The plurality of service offerings are then provided to a user requesting the cloud service to select the service offering.

At 154, a specific provider for the defined cloud service is selected from a plurality of available specific resources during a subscription stage. In one implementation, a plurality of parameters associated with the cloud service are generated the specific provider is selected at an expert system according to the generated plurality of parameters. In one implementation, the expert system is a rule-based expert system implementing a plurality of logical rules defined by a system administrator. The plurality of parameters can include any or all of a first set of parameters derived from the service blueprint, a second set of parameters derived from the service offering, and a third set of parameters derived from a characteristic of a user requesting the cloud service. At 156, the cloud service defined in the service offering using the selected specific provider. In one implementation, the service is provided by implementing the service defined in the service offering with the generic provider from the service blueprint replaced with the selected specific provider.

FIG. 5 is a schematic block diagram illustrating an exemplary system 200 of hardware components capable of implementing the example systems and methods for cloud service provisioning disclosed in FIGS. 1-4. The system 200 can include various systems and subsystems. The system 200 can be a personal computer, a laptop computer, a workstation, a computer system, an appliance, an application-specific integrated circuit (ASIC), a server, a server blade center, a server farm, or any other appropriate processing component.

The system 200 can include a system bus 202, a processing unit 204, a system memory 206, memory devices 208 and 210, a communication interface 212 (e.g., a network interface), a communication link 214, a display 216 (e.g., a video screen), and an input device 218 (e.g., a keyboard and/or a mouse). The system bus 202 can be in communication with the processing unit 204 and the system memory 206. The additional memory devices 208 and 210, such as a hard disk drive, server, stand alone database, or other non-volatile memory, can also be in communication with the system bus 202. The system bus 202 operably interconnects the processing unit 204, the memory devices 206-210, the communication interface 212, the display 216, and the input device 218. In some examples, the system bus 202 also operably interconnects an additional port (not shown). such as a universal serial bus (USB) port.

The processing unit 204 can be a computing device and can include an application-specific integrated circuit (ASIC). The processing unit 204 executes a set of instructions to implement the operations of examples disclosed herein. The processing unit can include a processing core.

The additional memory devices 206, 208 and 210 can store data, programs, instructions, database queries in text or compiled form, and any other information that can be needed to operate a computer. The memories 206, 208 and 210 can be implemented as computer-readable media (integrated or removable) such as a memory card, disk drive, compact disk (CD), or server accessible over a network, In certain examples, the memories 206, 208 and 210 can comprise text, images, video, and/or audio.

Additionally, the memory devices 208 and 210 can serve as databases or data storage. Additionally or alternatively, the system 200 can access an external data source through the communication interface 212, which can communicate with the system bus 202 and the communication link 214.

In operation, the system 200 can be used as all or part of a cloud provisioning system that utilizes generic resource providers at a design phase to delay the selection of a specific provider resource for a given element of the cloud service design. Computer executable logic for implementing the cloud provisioning system resides on one or more of the system memory 206, and the memory devices 208, 210 in accordance with certain examples. The processing unit 204 executes one or more computer executable instructions originating from the system memory 206 and the memory devices 208 and 210. The term “computer readable medium” as used herein can refer to a single medium or multiple discrete media that participate in providing instructions to the processing unit 204 for execution.

What have been described above are examples of the present invention. It is, of course, not possible to describe every conceivable combination of components or methodologies for purposes of describing the present invention, but one of ordinary skill in the art will recognize that many further combinations and permutations of the present invention are possible. Accordingly, the present invention is intended to embrace all such alterations, modifications, and variations that fall within the scope of the appended claims.

What is claimed is:

1. A cloud provisioning system comprising a memory resource and a processing resource to execute instructions from the memory resource, wherein the memory resource stores instructions comprising:
an expert system executable to select, for a generic resource provider defined in a service design generated at an associated design component, a specific resource provider from a plurality of available specific resource providers according to a set of parameters associated with the service design; and
a service delivery component executable to construct or manage a cloud service from the service design and the selected specific resource provider.

2. The cloud provisioning system of claim 1, wherein the expert system is executable to select the specific resource provider according to the set of parameters associated with the service design and a set of parameters associated with the plurality of available specific resource providers, the set of parameters associated with the plurality of available specific resource providers representing constraints on the plurality of available specific resource providers.

3. The cloud provisioning system of claim 1, wherein the expert system is executable to select the specific resource provider according to the set of parameters associated with the service design and a set of parameters drawn from a user context representing a characteristic of a user requesting the cloud service.

4. The cloud provisioning system of claim 1, wherein the set of parameters associated with the service design comprises a first set of parameters derived from an initial service blueprint for the service design and a second set of parameters derived from a service offering generated from the initial service blueprint by the design component.

5. The cloud provisioning system of claim 1, wherein the expert system is executable to select the specific resource provider according to the set of parameters associated with the service design and a set of parameters exposed to a user requesting the cloud service and directly selected by the user.

6. The cloud provisioning system of claim 1, wherein the expert system is executable to select the specific resource provider according to the set of parameters associated with the service design and a set of default parameters associated with the generic resource provider.

7. The cloud provisioning system of claim 1, wherein the generic resource provider is a first generic resource provider of a plurality of generic resource providers representing respective resource types, each generic resource provider of the plurality of generic resource providers comprising an expert system to select, for the service design, a specific resource provider of its represented resource type from a plurality of available specific resource providers of the represented type from the set of parameters associated with the service design.

8. The cloud provisioning system of claim 1, wherein the expert system is executable to select the specific resource provider according to the set of parameters associated with the service design and a set of parameters representing a system context.

9. The cloud provisioning system of claim 1, wherein the expert system is executable to perform policy-based provisioning and deployment as well as lifecycle management of resources according to a policy decision point to select which services and resources to deploy or provision and a manner in which the services and resources will be managed.

10. A method for providing a cloud service comprising:
generating a service design defining the cloud service during a design stage of cloud service provision, the generated service design being stored on a non-transitory computer readable medium;
selecting a specific provider for the defined cloud service from a plurality of available specific resources during a subscription stage; and
providing the cloud service defined in the service design using the selected specific provider.

11. The method of claim 10, wherein selecting a specific provider from the plurality of specific resources comprises:
generating a plurality of parameters associated with the cloud service; and
selecting the specific provider at an expert system according to the generated plurality of parameters.

12. The method of claim 11, wherein generating a service design defining the cloud service comprises:
generating a service blueprint representing the cloud service, the blueprint containing a generic provider for the cloud service;
generating a plurality of service offerings as instantiations of the service blueprint; and
providing the plurality of service offerings to a user requesting the cloud service to select a service offering.

13. The method of claim 11, wherein providing the cloud service defined in the service design comprises replacing the generic provider from the service blueprint with the specific provider.

14. The method of claim 11, wherein generating a plurality of parameters associated with the cloud service comprises generating a first set of parameters from the service blueprint and generating a second set of parameters from the service offering.

15. A method for providing a cloud service comprising:
generating a service blueprint representing the cloud service during a design stage of the cloud service provision, the blueprint containing a generic provider for the cloud service;
generating a plurality of service offerings as instantiations of the service blueprint;
providing the plurality of service offerings to a user requesting the cloud service to select the service offering during the design state;
storing the selected service offering to a non-transitory computer readable medium;
generating a first set of parameters from the service blueprint,
generating a second set of parameters from the service offering;
generating a third set of parameters according to a characteristic of a user requesting the cloud service;
selecting a specific provider for the defined cloud service from a plurality of available specific resources during a subscription stage using a rule-based expert system applying a plurality of logical rules defined by a system administrator to the first, second, and third sets of parameters; and
providing the cloud service defined in the service offering using the selected specific provider in place of the generic provider.
